(19) United States
(12) Patent Application Publication
(10) Pub. No.: US 2025/0249897 A1
(43) Pub. Date: Aug. 7, 2025

(54) VEHICULAR DRIVING ASSIST SYSTEM

(71) Applicant: Magna Electronics Inc., Auburn Hills, MI (US)

(72) Inventor: Wilhelm Johann Wolfgang Wöhlte, Sailauf (DE)

(21) Appl. No.: 19/190,934

(22) Filed: Apr. 28, 2025

Related U.S. Application Data
(63) Continuation of application No. 18/307,032, filed on Apr. 26, 2023, now Pat. No. 12,286,102.
(60) Provisional application No. 63/363,651, filed on Apr. 27, 2022.

(51) Int. Cl. B60W 30/09; B60W 10/18; B60W 10/20; B60W 10/30; B60W 30/095; B60W 50/16; G08G 1/16

(52) U.S. Cl. CPC B60W 30/09; B60W 10/18; B60W 10/20; B60W 10/30; B60W 30/0956; B60W 50/16; G08G 1/166; B60W 2420/403; B60W 2420/408; B60W 2554/408

(57) ABSTRACT

A vehicular driving assist system includes a forward-viewing camera disposed at a windshield of an equipped vehicle and a driver-side radar sensor and a passenger-side radar sensor disposed at respective sides of the equipped vehicle. An electronic control unit (ECU) includes at least one data processor. The vehicular driving assist system, via processing at the ECU of image data captured by the forward-viewing camera, determines a traffic lane along which the equipped vehicle is traveling. When proximity of a leading vehicle ahead of the equipped vehicle occludes view by the forward-viewing camera of oncoming traffic traveling in a direction opposite to that of the equipped vehicle and traveling along a left-side adjacent traffic lane, driver-side radar data captured by the driver-side radar sensor is processed to detect an oncoming vehicle traveling in the direction opposite to that of the equipped vehicle and traveling along the left-side adjacent traffic lane.

### CROSS REFERENCE TO RELATED APPLICATIONS

The present application is a continuation of U.S. patent application Ser. No. 18/307,032, filed Apr. 26, 2023, now U.S. Pat. No. 12,286,102, which claims the filing benefits of U.S. provisional application Ser. No. 63/363,651, filed Apr. 27, 2022, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular vision system includes a front camera disposed at a windshield of a vehicle equipped with the vehicular vision system that views at least forward of the equipped vehicle through the windshield and captures image data. The system also includes a side camera disposed at a side mirror of the equipped vehicle and viewing at least forward and sideward of the equipped vehicle that captures image data. The front camera includes a CMOS imaging array with at least one million photosensors arranged in rows and columns. The side camera includes a CMOS imaging array with at least one million photosensors arranged in rows and columns. The system includes an electronic control unit (ECU) with electronic circuitry and associated software. The electronic circuitry of the ECU includes an image processor for processing image data captured by the front camera and image data captured by the side camera. The vehicular vision system, via processing at the ECU of image data captured by the front camera, determines a traffic lane along which the equipped vehicle is traveling. The vehicular vision system detects a leading vehicle traveling in front of the equipped vehicle in the traffic lane along which the equipped vehicle is traveling. Responsive to determination of an intent of the equipped vehicle to change from the traffic lane along which the equipped vehicle is traveling to an adjacent traffic lane that is adjacent to the traffic lane along which the equipped vehicle is traveling, the vehicular vision system, via processing at the ECU of image data captured by the side camera, detects an oncoming vehicle traveling in the adjacent traffic lane.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIGS. 2 and 3 are schematic views of a vehicle performing an overtaking maneuver with an oncoming vehicle;

FIG. 4 is a schematic view of a vehicle detecting an oncoming vehicle with a sensor mounted at a bumper of the vehicle; and

FIG. 5 is a schematic view of a vehicle detecting an oncoming vehicle with a sensor mounted at a side mirror of the vehicle.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

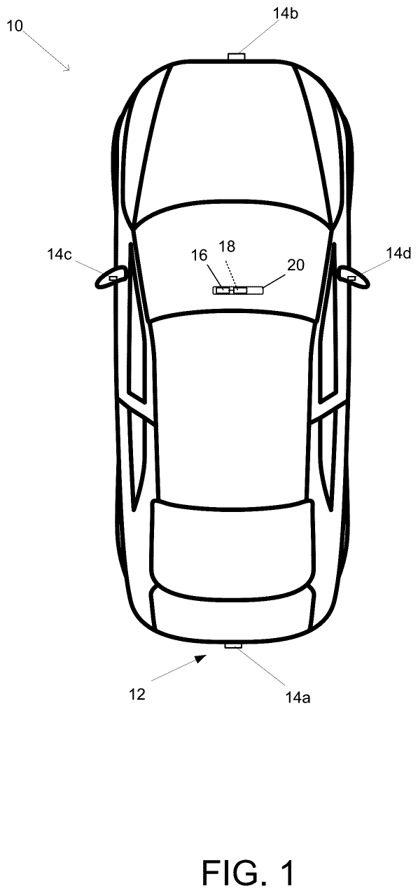

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

An overtaking maneuver is commonly defined as a traffic maneuver where a vehicle passes another vehicle traveling in the same direction. When travelling along a single-lane road, overtaking maneuvers involve temporarily driving in the same lane as oncoming traffic, increasing the risk of the maneuver.

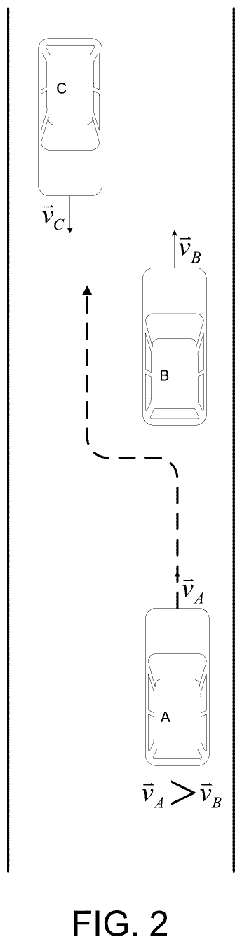

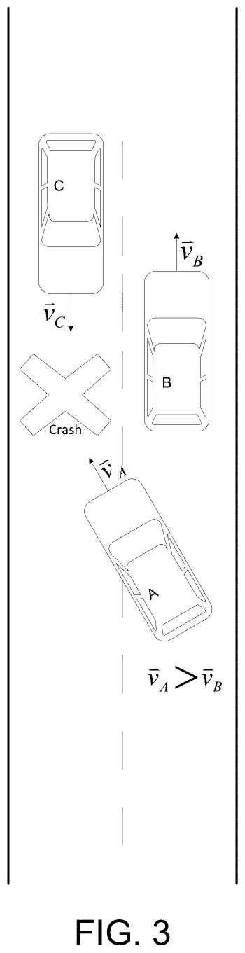

Implementations herein include an overtaking anti-collision assist system that assists in avoiding collisions with oncoming traffic during overtaking maneuvers. For example, as shown in FIG. 2, a first vehicle (vehicle A) is driving behind a second vehicle (vehicle B) in the same traffic lane of a multi-lane road (e.g., a two-lane road). Vehicle B may be any type of vehicle (e.g., a car, a truck, a motorbike, a bicycle, etc.). Vehicle A travels faster than Vehicle B (i.e., VA>VB) and begins an overtaking maneuver. However, a third vehicle (vehicle C) is oncoming on the opposite lane and vehicle A is unaware of vehicle C (e.g., vehicle C is obscured by vehicle A or the environment or the driver is distracted). As shown in FIG. 3, an overtaking maneuver is this situation may lead to a collision between vehicle A and vehicle C.

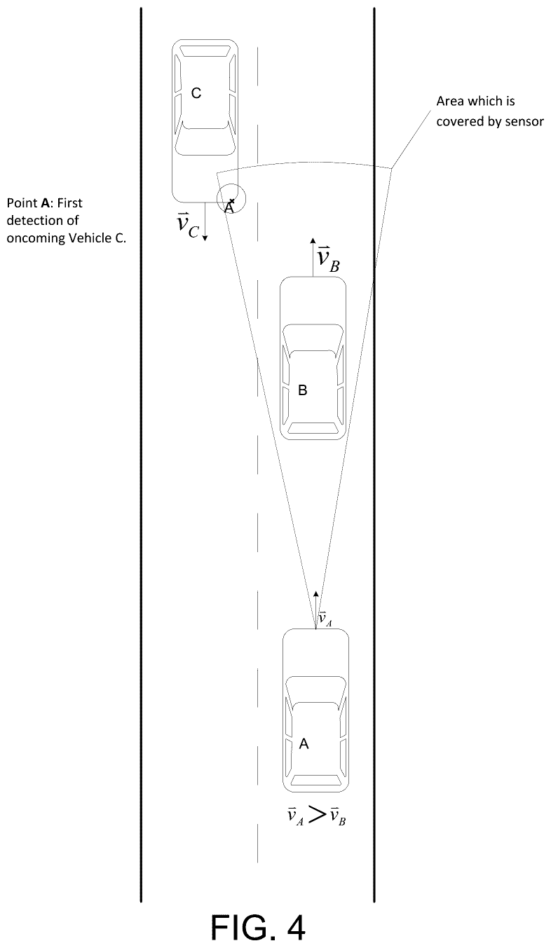

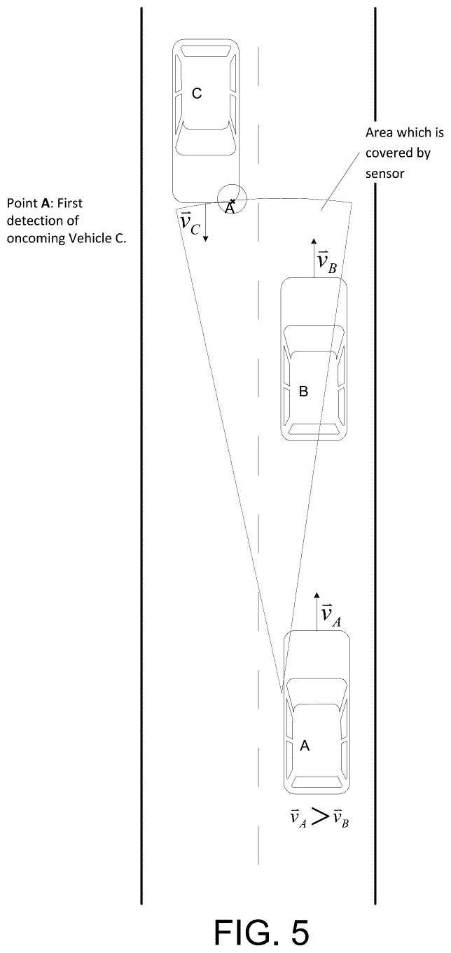

Referring now to FIGS. 4 and 5, an advanced driver assistance system (ADAS) may include an imaging or ranging sensor (e.g., a camera, such as cameras 14a-d, a radar sensor, a LIDAR sensor, etc.) at a front or corner of the equipped vehicle (FIG. 4) or at a side mirror of the equipped vehicle (FIG. 5) to detect and recognize oncoming vehicles.

Based on sensor data captured by an imaging or non-imaging sensing sensor (e.g., a camera, a radar sensor, etc.), the ADAS may provide a message to the driver or the equipped vehicle and a crash avoidance routine (active or passive) may be started. For example, a passive crash avoidance routine may include generating a visual warning (e.g., on a display disposed within the vehicle, on a head-up display (HUD), etc.), generating an acoustic or audible warning, generating a haptic warning (e.g. vibration of steering wheel or seat), etc.

Additionally or alternatively, the system may include an active crash avoidance routine that, for example, disables or resists turning the steering wheel in direction of oncoming traffic to help stop the overtaking maneuver from beginning, slowing the vehicle or slowing or stopping a speed or acceleration of the vehicle, prefilling a brake (e.g., to prepare for emergency braking), tensioning a seat belt of one or more occupants of the vehicle, preparing airbags, etc.

Thus, the system can provide either or both an passive warning or actively attempt to reduce the likelihood of a collision or mitigate the consequence of a collision via controlling one or more systems of the vehicle (e.g., braking, steering, acceleration, seat belts, air bags, etc.).

The system may be used for left and right hand traffic (e.g., configurable via software). The forward sensing/imaging sensor can be mounted in different locations. For example, the sensor(s) may be mounted at or near the side mirrors (FIG. 5), at/in/behind the front bumper (FIG. 4), or behind the windshield as is common with front camera modules (FMCs). Each side mirror may include a camera and the system may use whichever camera is closer to oncoming traffic (i.e., the left side mirror camera in areas where vehicles drive on the right side of the road and the right side mirror camera in areas where vehicles drive on the left side of the road). The system may be configured (e.g., during manufacturing) to use sensors on one side of the vehicle versus another side. In other examples, the system automatically determines which sensor(s) to use (e.g., based on processing sensor data from each sensor, based on a location of a vehicle determined from a GPS sensor, etc.).

Mounting the sensors toward a side of the vehicle (e.g., at the side mirrors, at a corner of a bumper, etc.), may increase the field of view of the oncoming traffic lane. For example, as can be seen with reference to the field of view of the sensor in FIG. 4 and the field of view of the sensor in FIG. 5, the field of view of the sensor in FIG. 5 is able to view/detect the oncoming vehicle at a greater distance. The oncoming traffic can be any road user, such as cars, trucks, motorcycles, bicycles. Optionally, the system may be used to detect other objects that are not a vehicle but are otherwise blocking the lane and are a collision risk (e.g., pedestrians, animals, tree limbs, etc.).

The system may be used when traffic ahead of the equipped vehicle is slower than the equipped vehicle and the equipped vehicle desires to overtake. For example, vehicle B of FIGS. 2-4 may be parked or stopped. When the system detects that an oncoming vehicle poses a collision risk, the system may engage a steering lock or other system to inhibit the overtaking maneuver. The system may determine, via processing the sensor data captured by the forward-viewing sensor, that the oncoming object no longer poses a collision threat (e.g., the oncoming object turned or passed the equipped vehicle, and in response, the system may release the steering wheel lock or any other safety mechanism.

During operation, the system may detect at least two targets. For example, the system detects a first object moving in the same direction as the equipped vehicle (i.e., the leading vehicle) and at a second object travelling in the opposite direction (i.e., the oncoming vehicle). The sensor(s) (e.g., one or more cameras, one or more radar sensors, one or more LIDAR sensors, etc.) may work independent of other ADAS such as lane-keep assist systems and operate regardless of current lane markings and turn signals (i.e., without the driver indicating they are preparing to overtake).

The system may use multiple sensors. For example, the system may use a camera mounted at or behind a windshield of the vehicle in conjunction with a camera mounted at a side mirror of the vehicle and/or a radar sensor disposed at the front and/or at the front corner and/or side mirror of the vehicle. The system may use any form of sensor fusion to evaluate the sensor data from multiple sensors. The passive warning and/or the active interventions may be user-configurable. For example, the user may enable passive warnings (e.g., visual and/or audible alerts) and disable active interventions (e.g., steering and/or brake control). The system may detect a leading vehicle and/or the current traffic lane (e.g., lane markers) using a first sensor (e.g., a windshield-mounted camera) and may detect a leading vehicle in the current traffic lane via the first sensor and/or via a forward-sensing radar sensor, and may detect an oncoming vehicle in an adjacent traffic lane using a second sensor (e.g., a side-mounted camera, such as a camera mounted at a side mirror of the vehicle, or a sideward and forward sensing radar sensor, such as a radar sensor mounted at a front corner of the vehicle or at a side mirror of the equipped vehicle).

The system may always be engaged. That is, the passive warning and/or active interventions may always be active whenever the system determines an oncoming vehicle poses a collision risk during any potential overtake maneuver. In other examples, the system predicts or determines an upcoming overtake maneuver and only engages the passive warning and/or active interventions when the likelihood of an imminent overtake maneuver satisfies a threshold. For example, the system may determine an overtake maneuver based on an increase in speed in the equipped vehicle, a turn signal, lateral movement in the equipped vehicle, etc. The system may enable the passive warnings of the system whenever an oncoming vehicle is detected and enable active interventions only when the system determines the likelihood of a collision exceeds a threshold value.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize other sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

The invention claimed is:

1. A vehicular driving assist system, the vehicular driving assist system comprising:
a forward-viewing camera disposed at a windshield of a vehicle equipped with the vehicular driving assist system and viewing at least forward of the equipped vehicle through the windshield, wherein the forward-viewing camera is operable to capture image data;
wherein the forward-viewing camera comprises an imaging array, and wherein the imaging array of the forward-viewing camera comprises at least one million photosensors arranged in rows and columns;
a driver-side radar sensor disposed at a driver side of the equipped vehicle and viewing at least forward and sideward of the equipped vehicle, wherein the driver-side radar sensor is operable to capture driver-side radar data;
a passenger-side radar sensor disposed at a passenger side of the equipped vehicle and viewing at least forward and sideward of the equipped vehicle, wherein the passenger-side radar sensor is operable to capture passenger-side radar data;
an electronic control unit (ECU) comprising electronic circuitry and associated software;
wherein the electronic circuitry of the ECU comprises at least one data processor;
wherein image data captured by the forward-viewing camera is transferred to and is processed at the ECU;
wherein driver-side radar data captured by the driver-side radar sensor is transferred to and is processed at the ECU;
wherein passenger-side radar data captured by the passenger-side radar sensor is transferred to and is processed at the ECU;
wherein the vehicular driving assist system, via processing at the ECU of image data captured by the forward-viewing camera, determines a traffic lane along which the equipped vehicle is traveling; and
wherein, when proximity of a leading vehicle ahead of the equipped vehicle occludes view by the forward-viewing camera of oncoming traffic traveling in a direction opposite to that of the equipped vehicle and traveling along a left-side adjacent traffic lane that is adjacent to and to the left of the traffic lane along which the equipped vehicle is traveling, driver-side radar data captured by the driver-side radar sensor is processed at the ECU to detect an oncoming vehicle traveling in the direction opposite to that of the equipped vehicle and traveling along the left-side adjacent traffic lane.

2. The vehicular driving assist system of claim 1, wherein, responsive to detecting, via processing at the ECU of driver-side radar data captured by the driver-side radar sensor, the oncoming vehicle traveling along the left-side adjacent traffic lane, an alert is generated to alert a driver of the equipped vehicle to presence of the detected oncoming vehicle.

3. The vehicular driving assist system of claim 2, wherein the alert comprises at least one selected from the group consisting of (i) a visual alert, (ii) an audible alert and (iii) a haptic alert.

4. The vehicular driving assist system of claim 1, wherein, responsive to detecting, via processing at the ECU of driver-side radar data captured by the driver-side radar sensor, the oncoming vehicle traveling along the left-side adjacent traffic lane, a crash avoidance function of the equipped vehicle is enabled.

5. The vehicular driving assist system of claim 4, wherein the crash avoidance function comprises at least one selected from the group consisting of (i) restricting steering of the equipped vehicle, (ii) restricting speed of the equipped vehicle, (iii) restricting acceleration of the equipped vehicle, (iv) prefilling a brake of the equipped vehicle and (v) tensioning a seat belt of the equipped vehicle.

6. The vehicular driving assist system of claim 4, wherein the vehicular driving assist system, responsive to determining that the oncoming vehicle has passed the equipped vehicle, disables the crash avoidance function.

7. The vehicular driving assist system of claim 4, wherein the vehicular driving assist system enables the crash avoidance function responsive to determining that a likelihood of a collision between the equipped vehicle and the oncoming vehicle is greater than a threshold.

8. The vehicular driving assist system of claim 1, wherein, responsive to detecting, via processing at the ECU of driver-side radar data captured by the driver-side radar sensor, the oncoming vehicle traveling along the left-side adjacent traffic lane, at least one selected from the group consisting of (i) steering of the equipped vehicle is controlled to avoid the detected oncoming vehicle and (ii) braking of the equipped vehicle is controlled to avoid the detected oncoming vehicle.

9. The vehicular driving assist system of claim 1, wherein the driver-side radar sensor is disposed at a front corner of the equipped vehicle.

10. The vehicular driving assist system of claim 1, wherein driver-side radar data captured by the driver-side radar sensor is processed at the ECU to detect the oncoming vehicle traveling along the left-side adjacent traffic lane responsive to intent of the equipped vehicle to change from the traffic lane along which the equipped vehicle is traveling to the left-side adjacent traffic lane.

11. The vehicular driving assist system of claim 10, wherein the vehicular driving assist system determines intent to change from the traffic lane based on at least one selected from the group consisting of (i) acceleration of the equipped vehicle, (ii) operation of a turn signal of the equipped vehicle and (iii) lateral movement of the equipped vehicle.

12. The vehicular driving assist system of claim 1, wherein driver-side radar data captured by the driver-side radar sensor is processed at the ECU to detect the oncoming vehicle responsive to detection of the leading vehicle ahead of the equipped vehicle via processing at the ECU of image data captured by the forward-viewing camera.

13. The vehicular driving assist system of claim 1, wherein the oncoming vehicle is detected via processing at the ECU of driver-side radar data captured by the driver-side radar sensor responsive to the equipped vehicle initiating a lane change to overtake the leading vehicle.

14. The vehicular driving assist system of claim 1, wherein the vehicular driving assist system detects the oncoming vehicle at least in part via processing of lidar data captured by at least one lidar sensor of the equipped vehicle.

15. The vehicular driving assist system of claim 1, wherein image data captured by the forward-viewing camera is processed at the ECU for at least one driving assistance system.

16. The vehicular driving assist system of claim 15, wherein the at least one driving assistance system comprises at least one selected from the group consisting of (i) a traffic sign recognition system of the equipped vehicle, (ii) a headlamp control system of the equipped vehicle, (iii) a pedestrian detection system of the equipped vehicle and (iv) a collision avoidance system of the equipped vehicle.

17. The vehicular driving assist system of claim 1, wherein, when proximity of the leading vehicle ahead of the equipped vehicle occludes view by the forward-viewing camera of oncoming traffic traveling in the direction opposite to that of the equipped vehicle and traveling along a right-side adjacent traffic lane that is adjacent to and to the right of the traffic lane along which the equipped vehicle is traveling, passenger-side radar data captured by the passenger-side radar sensor is processed at the ECU to detect an oncoming vehicle traveling in the direction opposite to that of the equipped vehicle and traveling along the right-side adjacent traffic lane.

18. The vehicular driving assist system of claim 17, wherein passenger-side radar data captured by the passenger-side radar sensor is processed at the ECU to detect the oncoming vehicle traveling in the direction opposite to that of the equipped vehicle and traveling along the right-side adjacent traffic lane responsive to intent of the equipped vehicle to change from the traffic lane along which the equipped vehicle is traveling to the right-side adjacent traffic lane.

19. The vehicular driving assist system of claim 18, wherein passenger-side radar data captured by the passenger-side radar sensor is processed at the ECU to detect the oncoming vehicle traveling in the direction opposite to that of the equipped vehicle and traveling along the right-side adjacent traffic lane responsive to detecting the leading vehicle ahead of the equipped vehicle.

20. The vehicular driving assist system of claim 18, wherein the oncoming vehicle is detected via processing at the ECU of passenger-side radar data captured by the passenger-side radar sensor responsive to the equipped vehicle initiating a lane change to overtake the leading vehicle.

21. A vehicular driving assist system, the vehicular driving assist system comprising:
a forward-viewing camera disposed at a windshield of a vehicle equipped with the vehicular driving assist system and viewing at least forward of the equipped vehicle through the windshield, wherein the forward-viewing camera is operable to capture image data;
wherein the forward-viewing camera comprises an imaging array, and wherein the imaging array of the forward-viewing camera comprises at least one million photosensors arranged in rows and columns;
a driver-side radar sensor disposed at a driver side of the equipped vehicle and viewing at least forward and sideward of the equipped vehicle, wherein the driver-side radar sensor is operable to capture driver-side radar data;
a passenger-side radar sensor disposed at a passenger side of the equipped vehicle and viewing at least forward and sideward of the equipped vehicle, wherein the passenger-side radar sensor is operable to capture passenger-side radar data;
an electronic control unit (ECU) comprising electronic circuitry and associated software;
wherein the electronic circuitry of the ECU comprises at least one data processor;
wherein image data captured by the forward-viewing camera is transferred to and is processed at the ECU;
wherein driver-side radar data captured by the driver-side radar sensor is transferred to and is processed at the ECU;
wherein passenger-side radar data captured by the passenger-side radar sensor is transferred to and is processed at the ECU;
wherein the vehicular driving assist system, via processing at the ECU of image data captured by the forward-viewing camera, determines a traffic lane along which the equipped vehicle is traveling;
wherein, when proximity of a leading vehicle ahead of the equipped vehicle occludes view by the forward-viewing camera of oncoming traffic traveling in a direction opposite to that of the equipped vehicle and traveling along a left-side adjacent traffic lane that is adjacent to and to the left of the traffic lane along which the equipped vehicle is traveling, driver-side radar data captured by the driver-side radar sensor is processed at the ECU to detect an oncoming vehicle traveling in the direction opposite to that of the equipped vehicle and traveling along the left-side adjacent traffic lane;
wherein the oncoming vehicle is detected via processing at the ECU of driver-side radar data captured by the driver-side radar sensor responsive to the equipped vehicle initiating a lane change to overtake the leading vehicle;
wherein, when proximity of the leading vehicle ahead of the equipped vehicle occludes view by the forward-viewing camera of oncoming traffic traveling in the direction opposite to that of the equipped vehicle and traveling along a right-side adjacent traffic lane that is adjacent to and to the right of the traffic lane along which the equipped vehicle is traveling, passenger-side radar data captured by the passenger-side radar sensor is processed at the ECU to detect an oncoming vehicle traveling in the direction opposite to that of the equipped vehicle and traveling along the right-side adjacent traffic lane; and
wherein the oncoming vehicle is detected via processing at the ECU of passenger-side radar data captured by the passenger-side radar sensor responsive to the equipped vehicle initiating a lane change to overtake the leading vehicle.

22. The vehicular driving assist system of claim 21, wherein, responsive to detecting, via processing at the ECU of driver-side radar data captured by the driver-side radar sensor, the oncoming vehicle traveling along the left-side adjacent traffic lane, an alert is generated to alert a driver of the equipped vehicle to presence of the detected oncoming vehicle, and wherein the alert comprises at least one selected from the group consisting of (i) a visual alert, (ii) an audible alert and (iii) a haptic alert.

23. The vehicular driving assist system of claim 21, wherein, responsive to detecting, via processing at the ECU of driver-side radar data captured by the driver-side radar sensor, the oncoming vehicle traveling along the left-side adjacent traffic lane, at least one selected from the group consisting of (i) steering of the equipped vehicle is controlled to avoid the detected oncoming vehicle and (ii) braking of the equipped vehicle is controlled to avoid the detected oncoming vehicle.

24. The vehicular driving assist system of claim 21, wherein, responsive to detecting, via processing at the ECU of driver-side radar data captured by the driver-side radar sensor, the oncoming vehicle traveling along the left-side adjacent traffic lane, at least one selected from the group consisting of (i) steering of the equipped vehicle is restricted, (ii) speed of the equipped vehicle is restricted, (iii) acceleration of the equipped vehicle is restricted, (iv) a brake of the equipped vehicle is prefilled and (v) a seat belt of the equipped vehicle is tensioned.

25. The vehicular driving assist system of claim 21, wherein driver-side radar data captured by the driver-side radar sensor is processed at the ECU to detect the oncoming vehicle traveling along the left-side adjacent traffic lane responsive to intent of the equipped vehicle to change from the traffic lane along which the equipped vehicle is traveling to the left-side adjacent traffic lane, and wherein the vehicular driving assist system determines intent to change from the traffic lane based on at least one selected from the group consisting of (i) acceleration of the equipped vehicle, (ii) operation of a turn signal of the equipped vehicle and (iii) lateral movement of the equipped vehicle.

26. A vehicular driving assist system, the vehicular driving assist system comprising:
a forward-viewing camera disposed at a windshield of a vehicle equipped with the vehicular driving assist system and viewing at least forward of the equipped vehicle through the windshield, wherein the forward-viewing camera is operable to capture image data;
wherein the forward-viewing camera comprises an imaging array, and wherein the imaging array of the forward-viewing camera comprises at least one million photosensors arranged in rows and columns;
a driver-side radar sensor disposed at a driver side of the equipped vehicle and viewing at least forward and sideward of the equipped vehicle, wherein the driver-side radar sensor is operable to capture driver-side radar data;
a passenger-side radar sensor disposed at a passenger side of the equipped vehicle and viewing at least forward and sideward of the equipped vehicle, wherein the passenger-side radar sensor is operable to capture passenger-side radar data;
wherein the driver-side radar sensor is disposed at a driver side front corner of the equipped vehicle, and wherein the passenger-side radar sensor is disposed at a passenger side front corner of the equipped vehicle;
an electronic control unit (ECU) comprising electronic circuitry and associated software;
wherein the electronic circuitry of the ECU comprises at least one data processor;
wherein image data captured by the forward-viewing camera is transferred to and is processed at the ECU;
wherein driver-side radar data captured by the driver-side radar sensor is transferred to and is processed at the ECU;
wherein passenger-side radar data captured by the passenger-side radar sensor is transferred to and is processed at the ECU;
wherein the vehicular driving assist system, via processing at the ECU of image data captured by the forward-viewing camera, determines a traffic lane along which the equipped vehicle is traveling;
wherein, when proximity of a leading vehicle ahead of the equipped vehicle occludes view by the forward-viewing camera of oncoming traffic traveling in a direction opposite to that of the equipped vehicle and traveling along a left-side adjacent traffic lane that is adjacent to and to the left of the traffic lane along which the equipped vehicle is traveling, driver-side radar data captured by the driver-side radar sensor is processed at the ECU to detect an oncoming vehicle traveling in the direction opposite to that of the equipped vehicle and traveling along the left-side adjacent traffic lane; and
wherein driver-side radar data captured by the driver-side radar sensor is processed at the ECU to detect the oncoming vehicle traveling along the left-side adjacent traffic lane responsive to intent of the equipped vehicle to change from the traffic lane along which the equipped vehicle is traveling to the left-side adjacent traffic lane.

27. The vehicular driving assist system of claim 26, wherein, responsive to detecting, via processing at the ECU of driver-side radar data captured by the driver-side radar sensor, the oncoming vehicle traveling along the left-side adjacent traffic lane, an alert is generated to alert a driver of the equipped vehicle to presence of the detected oncoming vehicle, and wherein the alert comprises at least one selected from the group consisting of (i) a visual alert, (ii) an audible alert and (iii) a haptic alert.

28. The vehicular driving assist system of claim 26, wherein, responsive to detecting, via processing at the ECU of driver-side radar data captured by the driver-side radar sensor, the oncoming vehicle traveling along the left-side adjacent traffic lane, at least one selected from the group consisting of (i) steering of the equipped vehicle is restricted, (ii) speed of the equipped vehicle is restricted, (iii) acceleration of the equipped vehicle is restricted, (iv) a brake of the equipped vehicle is prefilled and (v) a seat belt of the equipped vehicle is tensioned.

29. The vehicular driving assist system of claim 26, wherein, responsive to detecting, via processing at the ECU of driver-side radar data captured by the driver-side radar sensor, the oncoming vehicle traveling along the left-side adjacent traffic lane, at least one selected from the group consisting of (i) steering of the equipped vehicle is controlled to avoid the detected oncoming vehicle and (ii) braking of the equipped vehicle is controlled to avoid the detected oncoming vehicle.

30. The vehicular driving assist system of claim 26, wherein driver-side radar data captured by the driver-side radar sensor is processed at the ECU to detect the oncoming vehicle traveling along the left-side adjacent traffic lane responsive to intent of the equipped vehicle to change from the traffic lane along which the equipped vehicle is traveling to the left-side adjacent traffic lane, and wherein the vehicular driving assist system determines intent to change from the traffic lane based on at least one selected from the group consisting of (i) acceleration of the equipped vehicle, (ii) operation of a turn signal of the equipped vehicle and (iii) lateral movement of the equipped vehicle.

31. The vehicular driving assist system of claim 26, wherein the vehicular driving assist system determines intent to change from the traffic lane based on lateral movement of the equipped vehicle.

32. The vehicular driving assist system of claim 26, wherein driver-side radar data captured by the driver-side radar sensor is processed at the ECU to detect the oncoming vehicle responsive to detection of the leading vehicle ahead of the equipped vehicle via processing at the ECU of image data captured by the forward-viewing camera.

33. The vehicular driving assist system of claim 26, wherein the oncoming vehicle is detected via processing at the ECU of driver-side radar data captured by the driver-side radar sensor responsive to the equipped vehicle initiating a lane change to overtake the leading vehicle.

34. The vehicular driving assist system of claim 26, wherein image data captured by the forward-viewing camera is processed at the ECU for at least one driving assistance system, and wherein the at least one driving assistance system comprises at least one selected from the group consisting of (i) a traffic sign recognition system of the equipped vehicle, (ii) a headlamp control system of the equipped vehicle, (iii) a pedestrian detection system of the equipped vehicle and (iv) a collision avoidance system of the equipped vehicle.
